(19) United States
(12) Patent Application Publication
(10) Pub. No.: US 2025/0383514 A1
(43) Pub. Date: Dec. 18, 2025

(54) OPTICAL TRANSCEIVING ASSEMBLY

(71) Applicant: Innolight Technology(ChengDu)LTD., Chengdu (CN)

(72) Inventors: Xiuling Deng, Chengdu, Sichuan Province (CN); Yin Wei, Chengdu, Sichuan Province (CN); Peng Xiao, Chengdu, Sichuan Province (CN); Lingjie Yi, Chengdu, Sichuan Province (CN)

(21) Appl. No.: 18/871,156

(22) PCT Filed: Apr. 27, 2023
(86) PCT No.: PCT/CN2023/091069

§ 371 Date: Dec. 3, 2024

(30) Foreign Application Priority Data
Jun. 21, 2022 (CN) 202221560110.X

(51) Int. Cl. G02B 6/42

(52) U.S. Cl. CPC G02B 6/4246

(57) ABSTRACT

An optical transceiving assembly, comprising a circuit board, and optical transceiving lenses and at least two optoelectronic chips which are arranged on the circuit board, the circuit board being electrically connected to the at least two optoelectronic chips. Each optical transceiving lens is provided with optical filters corresponding to the at least two optoelectronic chips, the optical filters achieving light beam combination or splitting. Each optical transceiving lens comprises at least one channel spacing adjusting member. When light beams are emitted from the at least two optoelectronic chips respectively, the light beams are reflected to the optical filters via a channel spacing adjusting member, and after the channel spacing adjusting member increases the spacing between at least two adjacent light beams emitted from the at least two optoelectronic chips, the light beams arrive at the optical filters. By arranging the channel spacing adjusting members on the optical transceiving lenses, the distance between the adjacent optoelectronic chips is reduced, so that the overall dimension of an optical module can be reduced without patching single-channel optical chips in a scattered manner, thereby reducing the manufacturing cost of the optical module.

### CROSS-REFERENCE TO RELATED PATENT APPLICATION

This application claims priority to the Chinese patent application filed with the China Patent Office on Jun. 21, 2022, with the application No. 202221560110.X and the invention name “Optical Transceiving Assembly”, the entire content of which is incorporated into this application by reference.

### FIELD OF THE DISCLOSURE

This application relates to the field of optical communications, and in particular to an optical transceiving assembly.

### BACKGROUND TECHNIQUE

With the development of fiber optic communications, bandwidth requirements have increased explosively. At the same time, due to cost considerations, there is a need to minimize the hardware used to build network infrastructure. To achieve these two goals, the multiplexing mechanism has shifted from electrical signals to optical signals. One of the multiplexing methods is wavelength division multiplexing (WDM), which increases the transmission rate by enabling optical signals to achieve direct multiplexing and amplification, with individual wavelengths operating independently. However, using optical transceiving lenses with discrete optical filters for multiplexing and demultiplexing is limited by the size of the optical filters. This results in a large channel gap, requiring the use of spaced-out single-channel optical chips (e.g., photodiode (PD) or vertical-cavity surface-emitting laser (VCSEL)) to accommodate the channel gap. As a result, the overall size of the optical module increases, along with its manufacturing cost.

### SUMMARY OF THE DISCLOSURE

### Technical Problem

The purpose of this application is to provide an optical transceiving assembly that reduces the optical channel gap.

### Technical Solutions

In order to achieve one of the above-mentioned purposes of the application, one embodiment of the present application provides an optical transceiving assembly, including a circuit board, an optical transceiving lens disposed on the circuit board, and at least two optoelectronic chips, wherein the circuit board is electrically connected to the at least two optoelectronic chips, the optical transceiving lens is provided with an optical filter corresponding to the at least two optoelectronic chips to realize beam combining or splitting of light, characterized in that the optical transceiving lens includes at least one channel spacing adjustment member, and when light beams are emitted from the at least two optoelectronic chips respectively, the light beams are reflected to the optical filter via the at least one channel spacing adjustment member, and after the channel spacing adjusting member increases a spacing between at least two adjacent light beams emitted from the at least two optoelectronic chips, the light beams arrive at the optical filter.

As a further improvement of an embodiment of the application, the channel spacing adjustment member is provided between the optical filter and the optoelectronic chip, and the channel spacing adjustment member includes two mutually parallel total reflection surfaces, and in the two total reflection surfaces, one of the total reflection surfaces is aligned with the optoelectronic chip at a preset angle, while the other of the total reflection surfaces is aligned with the optical filter at a preset angle.

As a further improvement of an embodiment of the application, the optical transceiving assembly includes four optoelectronic chips, the four optoelectronic chips are all arranged along a first direction, the optical transceiving lens includes two channel spacing adjustments, and the two channel spacing adjustment members are arranged oppositely along the first direction.

As a further improvement of an embodiment of the application, the optical transceiving assembly includes four optical filters corresponding to the four optoelectronic chips, and the four optoelectronic chips are simultaneously configured as light emitting chips or light receiving chips.

As a further improvement of an embodiment of the application, the optical transceiving lens includes a bottom wall spaced apart from the circuit board, a side wall connected to an edge of the bottom wall and connected to the circuit board, two installation walls spaced apart from one end of the bottom wall away from the circuit board, the four optical filters are spaced apart along the first direction, and the channel spacing adjustment member is provided on the bottom wall.

As a further improvement of an embodiment of the application, a first molding groove is recessed at one end of the bottom wall close to the circuit board, and a second molding groove is recessed at one end of the bottom wall away from the circuit board; in the two total reflection surfaces of the channel spacing adjustment member, one of the two total reflection surfaces is formed on an inner wall of the first molding groove, and the other of the two total reflection surfaces is formed on an inner wall of the second molding groove.

As a further improvement of an embodiment of the application, the bottom wall has a second molding groove and two first molding grooves corresponding to the second molding groove, the second molding groove is located between adjacent first molding grooves, and the adjacent first molding grooves are arranged symmetrically with respect to an symmetry axis of the second molding groove, so that the two channel spacing adjusting members are symmetrical along the symmetry axis of the second molding groove.

As a further improvement of an embodiment of the application, a light-transmitting block is provided at one end of the bottom wall away from the circuit board, and the light-transmitting block has a first end surface and a second end surface opposite to each other along the first direction; in the two total reflection surfaces of the channel spacing adjustment member, one of the two total reflection surfaces is formed on the first end surface, and the other of the two total reflection surfaces is formed on the second end surface.

As a further improvement of an embodiment of the application, one end of the bottom wall away from the circuit board is provided with a mounting groove for accommodating two channel spacing adjustment members, and a distance between one of the two channel spacing adjustment members is greater than a distance between the other of the two channel spacing adjustment members and the circuit board, so as to reduce a width of the mounting groove along the first direction.

As a further improvement of an embodiment of the application, the optical transceiving assembly includes a first chip, a second chip, a third chip and a fourth chip arranged along the first direction, a first optical filter, a second optical filter, a third optical filter and a fourth optical filter arranged along the first direction, a first channel spacing adjustment member and a second channel spacing adjustment members arranged along a first direction, wherein the first optical filter, the second optical filter, the third optical filter and the fourth optical filter are parallel to each other and an included angle between the first optical filter, the second optical filter, the third optical filter and the fourth optical filter and the circuit board is 45°, and an included angle between the two total reflection surfaces of the first channel spacing adjustment member and the circuit boards is 45°, so that an incident light from the first chip is aligned with the second optical filter, an incident light from the second chip is reflected to the first channel spacing adjustment member through the first channel spacing adjustment member, an incident light from the third chip is reflected to the fourth optical filter through the second channel spacing adjusting member, and an incident light from the fourth chip is aligned with the third optical filter.

As a further improvement of an embodiment of the application, the optical transceiving lens is provided with a first lens corresponding to the optoelectronic chip, the first lens is disposed on one end of the bottom wall facing the circuit board, the optical transceiving lens further includes an adapting portion connected to the side wall and an optical port formed in the adapting portion, a second lens is provided in the adapting portion on an axis of the optical port, and the second lens and the optical filter are relatively arranged along the first direction.

### BENEFICIAL EFFECTS

Compared with existing technology, in the embodiment of this application, a channel spacing adjustment member is provided on the optical transceiving lens to reduce the distance between adjacent optoelectronic chips, thereby eliminating the need to separately mount single-channel optical chips, so as to reduce the overall size of the optical module and lowers the manufacturing cost.

### BRIEF DESCRIPTION OF THE DRAWINGS

FIG. 1 is a three-dimensional schematic view of an optical transceiving assembly in a preferred embodiment of the application;

FIG. 2 is an exploded schematic diagram of the optical transceiving assembly in FIG. 1;

FIG. 3 is a cross-sectional view of the optical transceiving assembly at A-A in FIG. 1;

FIG. 4 is a three-dimensional schematic diagram of the optical transceiving lens in FIG. 3;

FIG. 5 is a cross-sectional view of the optical transceiving lens at B-B in FIG. 4;

FIG. 6 is a schematic diagram of the optical path of the optical transceiving assembly in FIG. 3;

FIG. 7 is a cross-sectional view of the optical transceiving assembly at A-A in another preferred embodiment of the application;

FIG. 8 is a three-dimensional schematic diagram of the optical transceiving lens in FIG. 7;

FIG. 9 is a cross-sectional view of the optical transceiving lens at C-C in FIG. 8; and

FIG. 10 is a schematic diagram of the optical path of the optical transceiving assembly in FIG. 7.

### DETAILED DESCRIPTION OF THE EXEMPLARY EMBODIMENTS

The present application will be described in detail below with reference to the specific embodiments shown in the accompanying drawings. However, these embodiments do not limit the application. Structural, methodological, or functional modifications made by a person skilled in the art based on these embodiments fall within the scope of the application.

It should be understood that terms used herein, such as “upper,” “lower,” “outer,” “inner,” and similar expressions of spatial relationships, are used for convenience to describe the relative positions of elements or features as shown in the drawings. These spatially relative terms may also encompass different orientations of the device during use or operation, beyond the specific orientations depicted in the figures.

The drawings and the text include an arbitrarily defined XYZ coordinate system to assist in understanding the relative orientation of the various drawings. In the XYZ coordinate system, the X-axis or X-direction is parallel to the front and rear directions of the optical transceiving assembly and the propagation direction of light entering or exiting the optical port. The Z-axis or Z-direction is orthogonal to the Y-axis and generally defines the lateral direction. The Y-axis or Y-direction is orthogonal to both the X and Z axes and generally defines the vertical direction. The relative directionality terminology is used for clarity within the context of the XYZ coordinate system. For example, terms such as “backward,” “posterior,” and similar terms may refer to the positive X direction, while terms such as “forward,” “anterior,” and similar terms may refer to the negative X direction unless otherwise indicated by the context. Similarly, “upward,” “upper,” “top” and similar terms may refer to the positive Y direction, while “downward,” “lower,” “bottom,” and similar terms may refer to the negative Y direction, unless otherwise indicated by the context.

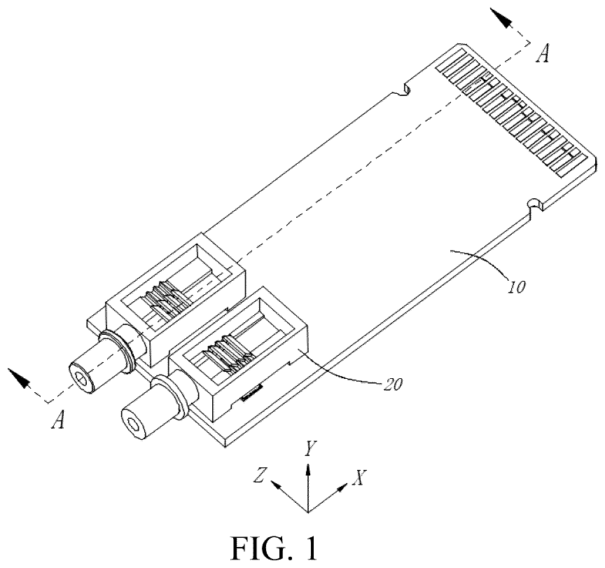

Referring to FIGS. 1 to 6, a preferred embodiment of the application provides an optical transceiving assembly. The optical transceiving assembly includes a light emitting component and a light receiving component, where the light emitting component is used to convert multiple different wavelengths. The optical carrier signals are combined together through a multiplexer and coupled to the same optical fiber of the optical line for transmission, wherein the optical receiving component is used to separate the received optical carrier signals of multiple different wavelengths through the demultiplexer. This enables simultaneous transmission of multiple optical signals of different wavelengths in the same optical fiber, and then a single optical fiber transmits multiple independent signals.

As shown in FIG. 1, specifically, an optical transceiving assembly includes a circuit board 10 and an optical transceiving lens 20 provided on the circuit board 10. In this embodiment, the optical transceiving lens 20 is made of polyetherimide (PEI for short) material, thereby realizing the transmission of optical signals within the optical transceiving lens 20. The optical transceiving lens 20 is fixed on the circuit board 10 by adhesive.

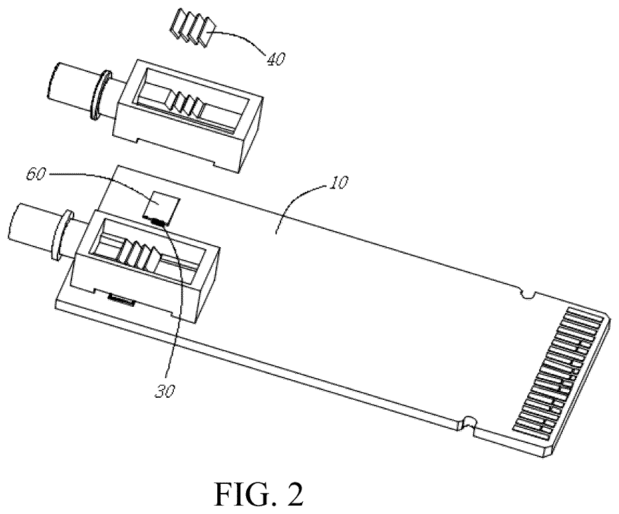

Referring to FIG. 2, specifically, the optical transceiving assembly further includes at least two optoelectronic chips 30 disposed on the circuit board 10, and the circuit board 10 is electrically connected to the at least two optoelectronic chips 30. In this embodiment, a driver 60 (dirver) is coupled to the circuit board 10, and the driver 60 and the optoelectronic chip 30 are electrically connected through wiring.

Specifically, the optical transceiving lens 20 is provided with an optical filter 40 corresponding to the at least two optoelectronic chips 30, and the optical filter 40 realizes beam combining or splitting of light. In this embodiment, the optical filters 40 can transmit optical signals of specific wavelengths and reflect optical signals of other wavelengths. The number of optical filters 40 is the same as the number of optoelectronic chips 30. Using multiple optical filters 40 of different types, the optical signals emitted by multiple optoelectronic chips 30 can be multiplexed, or multiple received optical signals coupled in the same optical fiber can be demultiplexed, so that they can be received by multiple optoelectronic chips 30.

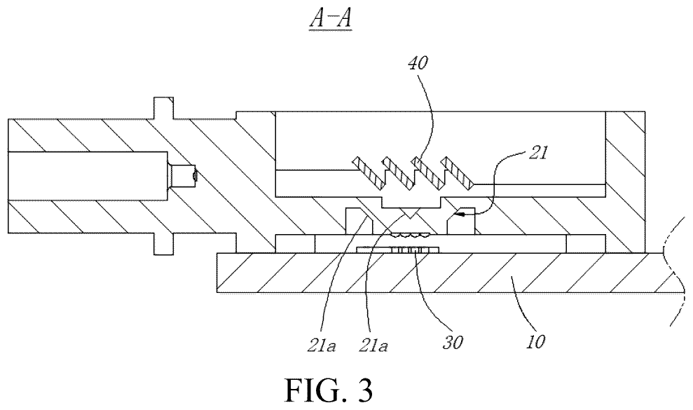

Referring to FIG. 3, further, the optical transceiving lens 20 includes at least one channel spacing adjustment member 21, and the channel spacing adjustment member 21 is disposed between the optical filter 40 and the optoelectronic chip 30. After the light beams are respectively emitted from the at least two optoelectronic chips 30, the light beams are reflected to the optical filter 40 through the channel spacing adjustment member 21. The distance between at least two adjacent beams of light emitted from the at least two optoelectronic chips 30 is increased by the channel spacing adjustment member 21, and then the at least two adjacent beams reaches the optical filter 40.

In this embodiment, when the optoelectronic chip 30 is used in a light emitting component, after the incident light from the optoelectronic chip 30 is reflected to the optical filter 40 through the channel spacing adjustment member 21, the channel gap between adjacent incident lights increases. According to the reversibility of the optical path, when the optoelectronic chip 30 is used in the light receiving component, the receiving end receives the optical signal and then transmits the optical signal to the optical filter 40, and the incident light from the optical filter 40 is reflected to the optoelectronic chip 30 through the channel spacing adjustment member 21, the channel gap between adjacent incident lights decreases. Therefore, while the size of the optical filter 40 and the adjacent spacing remain unchanged, the spacing between adjacent optoelectronic chips 30 is reduced, thereby reducing the wiring length between the driver 60 and the optoelectronic chip 30, and rationally arranging the driver 60 and the optoelectronic chip 30 arranged on the circuit board 10, thereby saving the space occupied by the optical transceiving assembly, so as to reduce the overall size of the optical module and lower the manufacturing cost. Moreover, using a single driver 60 to drive multiple optoelectronic chips 30 simultaneously shortens the wiring length and saves energy consumption of the circuit board 10.

By arranging the channel spacing adjustment member 21 on the optical transceiving lens 20, the distance between adjacent optoelectronic chips 30 is reduced, so that the need to disperse and mount single-channel optical chips is eliminated, thereby reducing the overall size of the optical module and the manufacturing cost.

Specifically, the channel spacing adjustment member 21 includes at least two mutually parallel total reflection surfaces 21a. In the two total reflection surfaces 21a, one of the two total reflection surfaces 21a is aligned with the optoelectronic chip 30 at a preset angle, and the other of the two total reflection surfaces 21a is aligned with the optical filter 40 at a preset angle.

In this embodiment, the channel spacing adjustment member 21 has two mutually parallel total reflection surfaces 21a, which are similar to the structure of a periscope, so that the outgoing light and the incident light after being reflected by the two total reflection surfaces 21a, are parallel to each other, and the distance between the incident light and the outgoing light is changed, then the distance between adjacent optoelectronic chips 30 is adjusted as needed. Therefore, The connecting line between the two total reflection surfaces 21a or the extending direction of the channel spacing adjustment member 21 is kept perpendicular to the incident light of the optoelectronic chip 30 or the filter 40 when setting.

In this way, when the incident light from one of the optoelectronic chip 30 and the optical filter 40 hits one of the total reflection surfaces 21a of the channel spacing adjustment member 21, the incident light is reflected to the other total reflection surface 21a of the channel spacing adjustment member by channel spacing adjustment member 21, and the reflected outgoing light is perpendicular to the incident light, then is reflected to one of the optoelectronic chip 30 and the optical filter 40 through the other total reflection surface 21a. The reflected outgoing light is perpendicular to the incident light.

Further, the optical transceiving assembly includes at least four optoelectronic chips 30, and the at least four optoelectronic chips 30 are all arranged along the first direction. The optical transceiving lens 20 includes at least two channel spacing adjustment members 21, and the two channel spacing adjusting members 21 are arranged oppositely along the first direction.

In this embodiment, the light emitting component or the light receiving component of the optical transceiving assembly includes four optoelectronic chips 30 to emit or receive optical signals of four different wavelengths. Then, through two corresponding channel spacing adjustment members 21, the spacing between adjacent optical signals or optical channels can be adjusted. The first direction is parallel to the X-axis direction, and the four optoelectronic chips 30 and the two channel spacing adjustment members 21 are arranged along the first direction, which can save the space of the optical transceiving assembly in the Y direction or Z direction. The two channel spacing adjustment members 21 are arranged oppositely along the first direction to ensure that the spacing between adjacent optoelectronic chips 30 is minimized.

Specifically, the optical transceiving assembly includes four optical filters 40 corresponding to the optoelectronic chips 30, and the at least four optoelectronic chips 30 are simultaneously configured as light emitting chips or light receiving chips. In this embodiment, when the optoelectronic chip 30 is used in a light emitting component, the optoelectronic chip 30 is configured as a laser emitting chip, that is, a vertical cavity surface emitting laser (VCSEL), for generating incident light signals. When the optoelectronic chip 30 is used in a light receiving component, the optoelectronic chip 30 is configured as a detector receiving chip, that is, a photodiode (Photo-Diode), for receiving incident light signals. Therefore, the light emitting component of the optical transceiving assembly includes four laser emitting chips arranged along the first direction. The optical receiving components of the optical transceiver component each include four detector receiving chips arranged along a first direction.

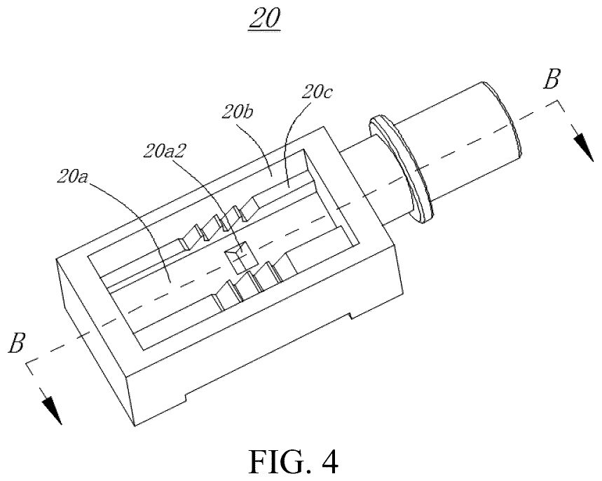

Referring to FIG. 4, specifically, the optical transceiving lens 20 includes a bottom wall 20a spaced apart from the circuit board 10, a side wall 20b connected to the periphery of the bottom wall 20a and connected to the circuit board 10, and two installation walls 20c spaced apart from each other, on the bottom wall 20, and away from the circuit board 10a. In this embodiment, the side wall 20b extends along the Y direction and is connected to the peripheral edge of the bottom wall 20a, and the side wall 20b is bonded to the circuit board 10, so that there is a certain gap between the bottom wall 20a and the circuit board 10 for mounting other optical components. The two installation walls 20c are both located in the side wall 20b and are arranged oppositely to the upper end of the bottom wall 20a along the Z direction.

Further, the optical filter 40 is spaced apart along the first direction on the two installation walls 20c, and the channel spacing adjustment member 21 is provided on the bottom wall 20a. In this embodiment, By setting a positioning groove matching the filter 40 at the top of the two mounting walls 20c, the optical filter 40 is limited in the positioning grooves. The cross section of the positioning groove is set to a “V” shape. Moreover, the optical filter 40 is also limited in the side wall 20b along the Z direction, and can be fixed on the positioning groove by adhesive in a later stage to improve the installation strength of the optical filter 40 on the optical transceiving lens 20. The optical filter 40, the channel spacing adjustment member 21 and the optoelectronic chip 30 are arranged along the Y direction. The channel spacing adjustment member 21 is disposed on the bottom wall 20a and is located in the side wall 20b, thereby being placed inside the optical transceiving lens 20 to avoid being affected by external factors during installation and use, and improve the stability of the channel spacing adjustment member 21 when in use.

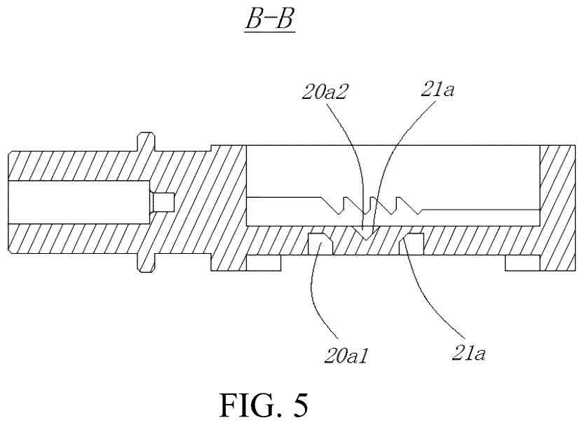

Referring to FIG. 5, specifically, a first molding groove 20al is recessed at one end of the bottom wall 20a close to the circuit board 10, and a second molding groove 20a2 is recessed at one end of the bottom wall 20a away from the circuit board 10. In the two total reflection surfaces 21a of the channel spacing adjustment member 21, one of the two total reflection surfaces 21a is formed on the inner wall of the first molding groove 20al, and the other of the two total reflection surfaces 21a is formed on the inner wall of the second molding groove 20a2.

In this embodiment, the first molding groove 20al and the second molding groove 20a2 are arranged oppositely at both ends of the bottom wall 20a along the Y direction. Moreover, the first molding groove 20al has an inner wall forming one of the two total reflection surfaces 21a, and the second molding groove 20a2 also has an inner wall forming the other of the two total reflection surfaces 21a. The inner walls of the two molding grooves are parallel to each other. Since the polyetherimide material adopted by the optical transceiving lens 20 is an optically dense medium, when light enters the air (optically sparse medium) from the optically dense medium and the incident angle is greater than the critical angle, a total reflection is generated, thus realizing reflection of the incident light on the inner walls of the two molding grooves.

Moreover, when the optical transceiving lens 20 is molded, the channel spacing adjustment member 21 is integrally formed on the optical transceiving lens 20, which can save the manufacturing cost of the optical transceiving assembly.

Further, the bottom wall 20a has at least one second molding groove 20a2 and two first molding grooves 20al corresponding to one second molding groove 20a2, and the second molding groove 20a2 is located between adjacent first molding grooves 20a1, and the adjacent first molding grooves 20al are arranged symmetrically with respect to the symmetry axis of the second molding groove 20a2, so that the two channel spacing adjustment members 21 are symmetrical along the symmetry axis of the second molding groove 20a2.

In this embodiment, as shown in FIG. 5, the cross section of the second molding groove 20a2 is set to a “V” shape, so that the two total reflection surfaces 21a of the two channel spacing adjustment members 21 are formed on both sides of the same second molding groove 20a2, so that the molding process of the second molding groove 20a2 can be omitted. The cross-section of the first molding groove 20al is set to an inverted “U” shape, and the two first molding grooves 20al are symmetrical with respect to the one second molding groove 20a2, which rationally utilizes the space of the bottom wall 20a and facilitates the forming and manufacturing of the first molding groove 20a1. In this way, when the corresponding total reflection surfaces 21a of the two channel spacing adjustment members 21 are formed on the light transceiving lens 20, the manufacturing cost is reduced.

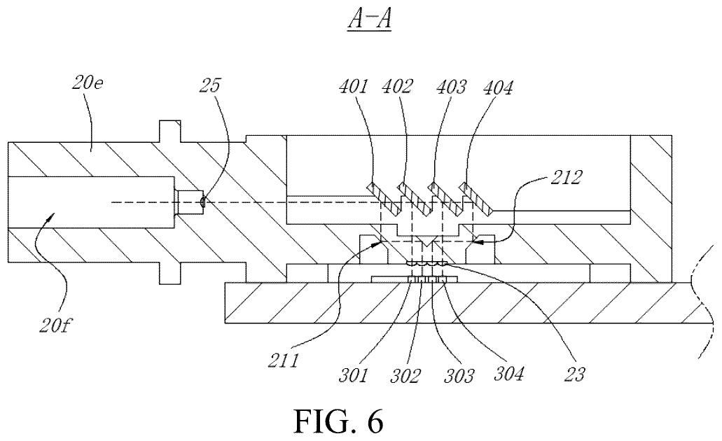

Referring to FIG. 6, further, the optical transceiving assembly includes a first chip 301, a second chip 302, a third chip 303 and a fourth chip 304 arranged along the first direction, an optical filter 401, a second optical filter 402, a third optical filter 403 and a fourth optical filter 404 arranged along the first direction, the first channel spacing adjustment member 211 and the second channel spacing adjustment member 212 arranged along the first direction. The first optical filter 301, the second optical filter 302, the third filter 303 and the fourth filter 304 are parallel to each other and the angle between the first optical filter 301, the second optical filter 302, the third filter 303 and the fourth filter 304 and the circuit board 10 is 45° and the included angle between the two total reflection surfaces 21a of the spacing adjustment member 211 and the circuit board 10 is 45°, so that the incident light from the first chip 301 is aligned with the second optical filter 402 and the second optical filter 402, the incident light from the chip 302 is reflected to the first optical filter 401 through the first channel spacing adjustment member 211, the incident light from the third chip 303 is reflected to the fourth optical filter 404 through the second channel spacing adjustment member 212, and the incident light from the fourth chip 304 is aligned with the third filter 403.

In this embodiment, the first optical filter 401, the second optical filter 402, the third filter 403 and the fourth filter 404 all form an angle of 45° with the negative X direction, the two total reflection surfaces 21a of the first channel spacing adjustment member 211 both form an included angle of 45° with the negative X direction, and the two total reflection surfaces 21a of the second channel spacing adjustment member 212 both form an included angle of 45° with the positive X direction.

When the optoelectronic chip 30 is used in a light emitting component, the first chip 301 generates an incident light with a wavelength 21, the second chip 302 generates an incident light with a wavelength 22, the third chip 303 generates an incident light with a wavelength 23, and the fourth chip 304 generates an incident light with wavelength 24.

The incident light generated by the first chip 301 directly passes through the bottom wall 20a and is incident toward the second optical filter 402. Since the second optical filter 402 can reflect light with the wavelength 21 and transmit light with other wavelengths, the incident light generated by the first chip 301 passes through the first optical filter 401 along the negative X direction, and finally exits the light transceiving lens 20.

The incident light generated by the second chip 302 is incident toward the total reflection surface 21a on the rear side of the first channel spacing adjustment member 211 through the bottom wall 20a, and is reflected to the total reflection surface 21a on the front side of the first channel spacing adjustment member 211 through the total reflection surface 21a, then is reflected to the first optical filter 401 through the total reflection surface 21a. Since the first optical filter 401 can reflect the light with the wavelength 22 and transmit light with other wavelengths, the incident light generated by the second chip 302 finally exits the light transceiving lens 20 along the negative X direction.

The incident light generated by the third chip 303 is incident toward the total reflection surface 21a on the front side of the second channel spacing adjustment member 212 through the bottom wall 20a, and is reflected to the total reflection surface 21a on the rear side of the second channel spacing adjustment member 212 through the total reflection surface 21a, then is reflected to the fourth filter 404 through the total reflection surface 21a. Since the fourth filter 404 can reflect the light with the wavelength 23 and transmit light with other wavelengths, the incident light generated by the third chip 303 passes through the third filter 403, the second optical filter 402, and the first optical filter 401 along the negative X direction, and finally exits the light transceiving lens 20.

The incident light generated by the fourth chip 304 is directly incident toward the third filter 403 through the bottom wall 20a. Since the third filter 403 can reflect light with the wavelength of 24 and transmit light with other wavelengths, the incident light generated by the fourth chip 304 passes through the second optical filter 402 and the first optical filter 401 along the negative X direction, and finally exits the light transceiving lens 20.

Moreover, since the first optical filter 401, the second optical filter 402, the third optical filter 403 and the fourth optical filter 404 are parallel to each other, the lights with the wavelengths 21, 22, 23 and 24 finally overlap each other and are emitted toward the outside of the light transceiving lens 20. In this way, the incident light of different wavelengths generated by the first chip 301, the second chip 302, the third chip 303 and the fourth chip 301 are finally merged together and coupled to the same optical fiber of the optical line for transmission, so as to achieve the function of transmitting multiple optical signals of different wavelengths simultaneously in the same optical fiber.

In addition, when the optoelectronic chip 30 is used in a light receiving component, due to the reversibility of the optical path, the received optical carrier signals of multiple different wavelengths can also be separated through the above structure, and are finally received by four corresponding light receiving chips.

Furthermore, the optical transceiving lens 20 is provided with a first lens 23 corresponding to the optoelectronic chip 30, and the first lens 23 is disposed on one end of the bottom wall 20a facing the circuit board 10. In this embodiment, the number of the first lenses 23 is the same as the number of optoelectronic chips 30, that is, the four first lenses 23 in FIG. 6. Moreover, the first lenses 23 are directly opposite to the optoelectronic chip 20, and the first lenses 23 are located directly above the optoelectronic chip 20. When the optoelectronic chip 30 is used in a light emitting chip, the first lens 23 can convert the divergent light beam emitted by the optoelectronic chip 30 into a collimated light beam. When the optoelectronic chip 30 is used as a light receiving chip, the first lens 23 can convert the incident light from the channel spacing adjustment member 21 or the optical filter 40 into a collimated light beam, thereby being received by the optoelectronic chip 30.

Furthermore, the optical transceiving lens 20 further includes an adapting portion 20e connected to the side wall 20b, and an optical port 20f formed in the adapting portion 20e. In this embodiment, the adapting portion 20e is used for docking with an external connector. After docking with the external connector, the optical fiber is located in the optical port 20f and coincides with the axis of the optical port 20f.

With reference to FIG. 1 and FIG. 6, it can be seen that the optical transceiving assembly has two adapting portions 20e, one is used as a transmitting optical path, and the other is used as a receiving optical path.

Furthermore, a second lens 25 is provided in the adapting portion 20e on the axis of the optical port 20f. The second lens 25 and the optical filter 40 are arranged oppositely along the first direction. In this embodiment, after the adapting portion 20e is connected to the external connector, the second lens 25 faces the external optical fiber. When the optoelectronic chip 30 is used in a light emitting chip, the second lens 25 can shape the light of different wavelengths reflected or transmitted through the plurality of optical filters 40 into convergent light, so that it can be received by the external optical fiber. When the optoelectronic chip 30 is used as a light receiving chip, the second lens 25 can shape the light beam transmitted from the external optical fiber into convergent light and make the convergent light incident toward the plurality of optical filters 40.

Referring to FIG. 1 and FIG. 7 to FIG. 10, another preferred embodiment of the application provides an optical transceiving assembly. In addition to the body design of the channel spacing adjustment member 21 of the optical transceiving assembly and the optical transceiving lens 20 being separated from each other, other structures are the same as those of the above embodiments. According to the user's needs for different optical channel spacing, different channel spacing adjustment members 21 can be replaced to match the optical transceiving lens 20 without the need to re-manufacture the optical transceiving lens 20 or replace the optical transceiving lens 20 as a whole, which saves manufacturing and replacement costs while meeting the different needs of users.

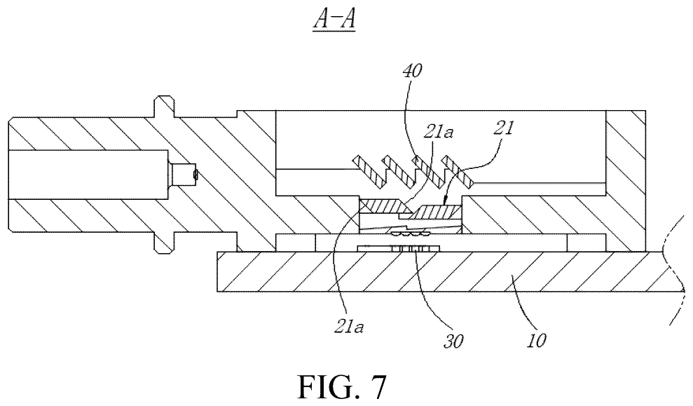

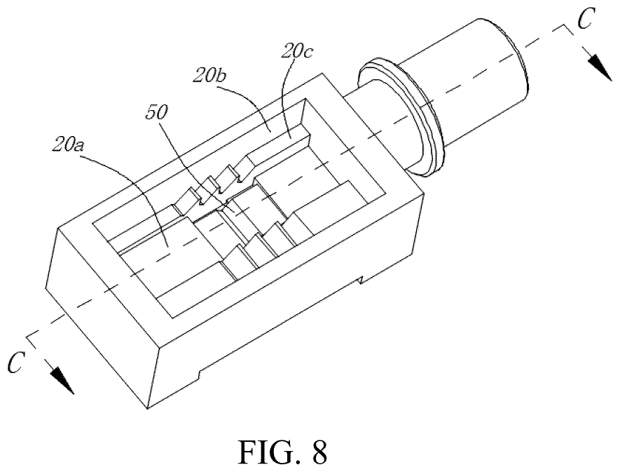

As shown in FIG. 7 and FIG. 8, specifically, a light-transmitting block 50 is provided at one end of the bottom wall 20a away from the circuit board 10. In this embodiment, the light-transmitting block 50 can be made of polyetherimide material or optical glass, and is fixed on the bottom wall 20a by bonding. The optical filter 40, the light-transmitting block 50 and the optoelectronic chip 30 are arranged along the Y direction.

Furthermore, the light-transmitting block 50 has a first end surface 50a and a second end surface 50b opposite to each other along the first direction. In the two total reflection surfaces 21a of the channel spacing adjustment member 21, one of the two total reflection surfaces 21 is formed on the first end surface 50a, and the other of the two total reflection surfaces 21 is formed on the second end surface 50b.

In this embodiment, since the incident light generated by the optoelectronic chip 30 is incident in a direction perpendicular to the lower end surface of the light-transmitting block 50, the incident light will directly enter the light-transmitting block 50 without reflection. Moreover, both the first end face 50a and the second end face 50b are arranged at a certain angle with the X direction. Since the polyetherimide material adopted by the light-transmitting block 50 is an optically dense medium, when light enters the air (optically sparse medium) from the optically dense medium and the incident angle is greater than the critical angle, a total reflection is generated, thereby realizing the reflection of incident light on both end surfaces.

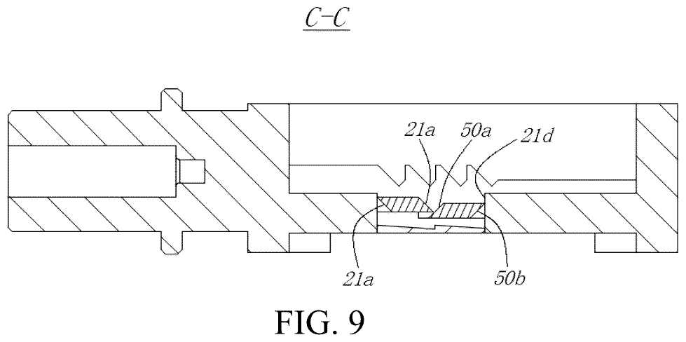

Referring to FIG. 9, further, one end of the bottom wall 20a facing away from the circuit board 10 is provided with a mounting groove 20d that accommodates at least two channel spacing adjustment members 21. The distance between one of the at least two channel spacing adjustment members 21 and the circuit board 10 is greater than the distance between the other of the at least two channel spacing adjustment members 21 and the circuit board 10 to reduce the groove width of the mounting groove 20d along the first direction. In this embodiment, the two channel spacing adjustment members 21 are unequal in distance from the circuit board 10 in the Y direction, which reduces the width of the mounting groove 20d in the X direction, thus saving the space occupied by the two light-transmitting blocks 50.

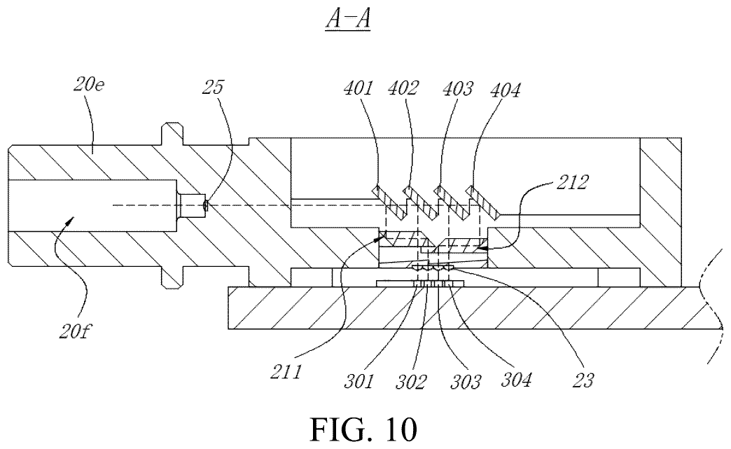

As shown in FIG. 10, in this embodiment, the two total reflection surfaces 21a of the first channel spacing adjustment member 211 are both at an angle of 45° with the negative X direction, and the two total reflection surfaces 21a of the second channel spacing adjustment member 212 are both at an angle of 45° with the positive X direction.

When the optoelectronic chip 30 is used in a light emitting component, the first chip 301 generates an incident light with a wavelength 21, the second chip 302 generates an incident light with a wavelength 22, the third chip 303 generates an incident light with a wavelength 23, and the fourth chip 303 generates an incident light with a wavelength 24.

The incident light generated by the first chip 301 is directly incident toward the second optical filter 402 through the bottom wall 20a and the first channel spacing adjustment member 211. Since the second optical filter 402 can reflect the light with the wavelength λ1 and transmit light with other wavelengths, the incident light generated by the first chip 301 passes through the first optical filter 401 along the negative X direction, and finally exits the light transceiving lens 20.

The incident light generated by the second chip 302 is incident toward the total reflection surface 21a on the rear side of the first channel spacing adjustment member 211 through the bottom wall 20a, and is reflected to the total reflection surface 21a on the front side of the first channel spacing adjustment member 211 through the total reflection surface 21a, then is reflected to the first optical filter 401 through the total reflection surface 21a. Since the first optical filter 401 can reflect the light with the wavelength 22 and transmit light with other wavelengths, the incident light generated by the second chip 302 finally exits the light transceiving lens 20 along the negative X direction.

The incident light generated by the third chip 303 is incident toward the total reflection surface 21a on the front side of the second channel spacing adjustment member 212 through the bottom wall 20a, and is reflected to the total reflection surface 21a on the rear side of the second channel spacing adjustment member 212 through the total reflection surface 21a, then is reflected to the fourth filter 404 through the total reflection surface 21a. Since the fourth filter 404 can reflect the light with the wavelength 23 and transmit light with other wavelengths, the incident light generated by the third chip 303 passes through the third filter 403, the second optical filter 402, and the first optical filter 401 along the negative X direction, and finally exits the light transceiving lens 20.

The incident light generated by the fourth chip 304 is incident toward the third filter 403 through the bottom wall 20a and the second channel spacing adjustment member 212. Since the third filter 403 can reflect the light with the wavelength 24 and transmit light with other wavelengths, the incident light generated by the fourth chip 304 passes through the second optical filter 402 and the first optical filter 401 along the negative X direction, and finally exits the light transceiving lens 20.

Moreover, since the first optical filter 401, the second optical filter 402, the third optical filter 403 and the fourth optical filter 404 are parallel to each other, the lights with the wavelengths 21, 22, 23 and 24 finally overlap each other and are emitted from the outside of the light transceiving lens 20. In this way, the incident light of different wavelengths generated by the first chip 301, the second chip 302, the third chip 303 and the fourth chip 301 are finally merged together and coupled to the same optical fiber of the optical line for transmission, so as to achieve the function of transmitting multiple optical signals of different wavelengths simultaneously in the same optical fiber.

In addition, when the optoelectronic chip 30 is used in a light receiving component, due to the reversibility of the optical path, the received optical carrier signals of multiple different wavelengths can also be separated through the above structure, and are finally received by four corresponding light receiving chips.

It should be understood that although this specification is described in terms of implementations, not each implementation only contains an independent technical solution. This description of the specification is only for the sake of clarity. Persons skilled in the art should take the specification as a whole and understand each individual solution. The technical solutions in the embodiments can also be appropriately combined to form other embodiments that can be understood by those skilled in the art.

The series of detailed descriptions listed above are only specific descriptions of feasible implementations of the present application. They are not intended to limit the protection scope of the present application. Any equivalents that do not deviate from the technical spirit of the present application implementations or changes should be included in the protection scope of the present application.

1. An optical transceiving assembly, including a circuit board, an optical transceiving lens disposed on the circuit board, and at least two optoelectronic chips, wherein the circuit board is electrically connected to the at least two optoelectronic chips, the optical transceiving lens is provided with an optical filter corresponding to the at least two optoelectronic chips to realize beam combining or splitting of light, characterized in that the optical transceiving lens includes at least one channel spacing adjustment member, and when light beams are emitted from the at least two optoelectronic chips respectively, the light beams are reflected to the optical filter via the at least one channel spacing adjustment member, and after the channel spacing adjusting member increases a spacing between at least two adjacent light beams emitted from the at least two optoelectronic chips, the light beams arrive at the optical filter.

2. The optical transceiving assembly according to claim 1, characterized in that, the channel spacing adjustment member is provided between the optical filter and the optoelectronic chip, and the channel spacing adjustment member includes two mutually parallel total reflection surfaces, and in the two total reflection surfaces, one of the total reflection surfaces is aligned with the optoelectronic chip at a preset angle, while the other of the total reflection surfaces is aligned with the optical filter at a preset angle.

3. The optical transceiving assembly of claim 2, characterized in that, the optical transceiving assembly includes four optoelectronic chips, the four optoelectronic chips are all arranged along a first direction, the optical transceiving lens includes two channel spacing adjustments, and the two channel spacing adjustment members are arranged oppositely along the first direction.

4. The optical transceiving assembly according to claim 3, characterized in that, the optical transceiving assembly includes four optical filters corresponding to the four optoelectronic chips, and the four optoelectronic chips are simultaneously configured as light emitting chips or light receiving chips.

5. The optical transceiving assembly of claim 3, characterized in that, the optical transceiving lens includes a bottom wall spaced apart from the circuit board, a side wall connected to an edge of the bottom wall and connected to the circuit board, two installation walls spaced apart from one end of the bottom wall away from the circuit board, the four optical filters are spaced apart along the first direction, and the channel spacing adjustment member is provided on the bottom wall.

6. The optical transceiving assembly of claim 5, characterized in that, a first molding groove is recessed at one end of the bottom wall close to the circuit board, and a second molding groove is recessed at one end of the bottom wall away from the circuit board; in the two total reflection surfaces of the channel spacing adjustment member, one of the two total reflection surfaces is formed on an inner wall of the first molding groove, and the other of the two total reflection surfaces is formed on an inner wall of the second molding groove.

7. The optical transceiving assembly of claim 6, characterized in that, the bottom wall has a second molding groove and two first molding grooves corresponding to the second molding groove, the second molding groove is located between adjacent first molding grooves, and the adjacent first molding grooves are arranged symmetrically with respect to an symmetry axis of the second molding groove, so that the two channel spacing adjusting members are symmetrical along the symmetry axis of the second molding groove.

8. The optical transceiving assembly according to claim 5, characterized in that, a light-transmitting block is provided at one end of the bottom wall away from the circuit board, and the light-transmitting block has a first end surface and a second end surface opposite to each other along the first direction; in the two total reflection surfaces of the channel spacing adjustment member, one of the two total reflection surfaces is formed on the first end surface, and the other of the two total reflection surfaces is formed on the second end surface.

9. The optical transceiving assembly according to claim 8, characterized in that, one end of the bottom wall away from the circuit board is provided with a mounting groove for accommodating two channel spacing adjustment members, and a distance between one of the two channel spacing adjustment members and the circuit board is greater than a distance between the other of the two channel spacing adjustment members and the circuit board, so as to reduce a width of the mounting groove along the first direction.

10. The optical transceiving assembly of claim 7, characterized in that, the optical transceiving assembly includes a first chip, a second chip, a third chip and a fourth chip arranged along the first direction, a first optical filter, a second optical filter, a third optical filter and a fourth optical filter arranged along the first direction, a first channel spacing adjustment member and a second channel spacing adjustment members arranged along a first direction, wherein the first optical filter, the second optical filter, the third optical filter and the fourth optical filter are parallel to each other and an included angle between the first optical filter, the second optical filter, the third optical filter and the fourth optical filter and the circuit board is 45°, and an included angle between the two total reflection surfaces of the first channel spacing adjustment member and the circuit boards is 45°, so that an incident light from the first chip is aligned with the second optical filter, an incident light from the second chip is reflected to the first optical filter through the first channel spacing adjustment member, an incident light from the third chip is reflected to the fourth optical filter through the second channel spacing adjusting member, and an incident light from the fourth chip is aligned with the third optical filter.

11. The optical transceiving assembly of claim 5, characterized in that, the optical transceiving lens is provided with a first lens corresponding to the optoelectronic chip, the first lens is disposed on one end of the bottom wall facing the circuit board, the optical transceiving lens further includes an adapting portion connected to the side wall and an optical port formed in the adapting portion, a second lens is provided in the adapting portion on an axis of the optical port, and the second lens and the optical filter are relatively arranged along the first direction.
